(19) United States
(12) Patent Application Publication
(10) Pub. No.: US 2009/0254870 A1
(43) Pub. Date: Oct. 8, 2009

(54) Automatic transistor arrangement device to arrange serially connected transistors, and method thereof

(75) Inventor: Masahiro Kojima, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/382,547

(22) Filed: Mar. 18, 2009

(30) Foreign Application Priority Data
Apr. 8, 2008 (JP) 2008-100576

(51) Int. Cl. G06F 17/50

(52) U.S. Cl. 716/2; 716/9

(57) ABSTRACT

When first and second hard macro transistors are arranged adjacently to each other, based on a circuit connection information and potentials of the first and second hard macro transistors are equal, a first programmable transistor is obtained by removing an unwanted diffusion region or an unwanted contact in the first hard macro transistor, and a second programmable transistor is obtained by removing an unwanted diffusion region or an unwanted contact in the second hard macro transistor. The first and second programmable transistors are arranged based on the circuit connection information.

### BACKGROUND OF THE INVENTION

1. Field of the Invention

The present invention relates to an automatic transistor arrangement device, and method, and more particularly to an automatic transistor arrangement device, and method used in layout design for LSI development.

2. Description of Related Art

In the layout design of conventional analog units, transistors corresponding to each element constituting the circuit are designed one by one, and arranged in prescribed regions. Further, many manual operations are required for the layout design. In recent LSI developments, however, the use of system LSI has increased, and the percentage of analog unit relative to the whole LSI has grown. Consequently, the conventional layout design may prolong the development period, so design automation is needed. There are tools for automatically arranging transistors. With the tools, however, manual layout modifications must be repeated many times to arrange the transistors in desired regions.

Thus, some techniques allowing layout design automation have been proposed. For example, Patent Document 1 describes a layout design method using parameters which universally represent transistor layout conditions; and Patent Document 2 describes a layout design device which includes means for estimating a point where diffusion sharing (sharing of diffusion region by transistors having the same potential) is made.

[Patent Document 1] Japanese Patent Laid-Open No. 9-036233

[Patent Document 2] Japanese Patent Laid-Open No. 11-003973

### SUMMARY

The following analysis has been performed by the present inventor. According to the layout design method described in Patent Document 1, layout design is made based on universal parameters, so when diffusion sharing is performed, there arises a problem of having a poor effect of area reduction.

An automatic transistor arrangement method of a first exemplary aspect of the present invention, includes, when first and second hard macro transistors are arranged adjacently to each other, based on a circuit connection information and potentials of the first and second hard macro transistors are equal, producing a first programmable transistor obtained by removing an unwanted diffusion region or an unwanted contact in the first hard macro transistor and producing a second programmable transistor obtained by removing an unwanted diffusion region or an unwanted contact in the second hard macro transistor; and arranging the first and second programmable transistors based on the circuit connection information.

According to the aspect, in arranging transistors automatically, the layout area can be reduced. The automatic transistor arrangement method produces, for hard macro transistors, programmable transistors obtained by removing diffusion regions equal in potential allowing diffusion sharing and/or unwanted contact and arranges the produced programmable transistors instead of arranging the hard macro transistors. That is, according to the method, the diffusion regions are shared by the transistors and/or the contacts are decreased, so that the layout area can be reduced.

### BRIEF DESCRIPTION OF THE DRAWINGS

The above and other exemplary aspects, advantages and features of the present invention will be more apparent from the following description of certain exemplary embodiments taken in conjunction with the accompanying drawings, in which:

FIG. 1 is a block diagram illustrating a configuration of an automatic transistor arrangement device according to an exemplary embodiment of the present invention;

FIG. 2 is a block diagram illustrating a configuration of an automatic transistor arrangement device according to a first exemplary embodiment of the present invention;

FIG. 3 is a flowchart illustrating the operation of the automatic transistor arrangement device according to the first exemplary embodiment of the present invention;

FIG. 4 is a block diagram illustrating a configuration of the automatic transistor arrangement device according to the first exemplary embodiment of the present invention;

FIG. 5 is a view illustrating an exemplary configuration of a virtual transistor file in the automatic transistor arrangement device according to the first exemplary embodiment of the present invention;

FIG. 6 is a view for describing the operation of the automatic transistor arrangement device according to the first exemplary embodiment of the present invention;

FIG. 7 is a view illustrating a transistor circuit for which the number of gate divisions is three and a programmable transistor associated with the transistor circuit;

FIG. 8 is a view for describing the operation of an automatic transistor arrangement device according to a second exemplary embodiment of the present invention; and

FIG. 9 is a view illustrating a transistor circuit and a programmable transistor associated with the transistor circuit.

### DETAILED DESCRIPTION OF THE EXEMPLARY EMBODIMENTS

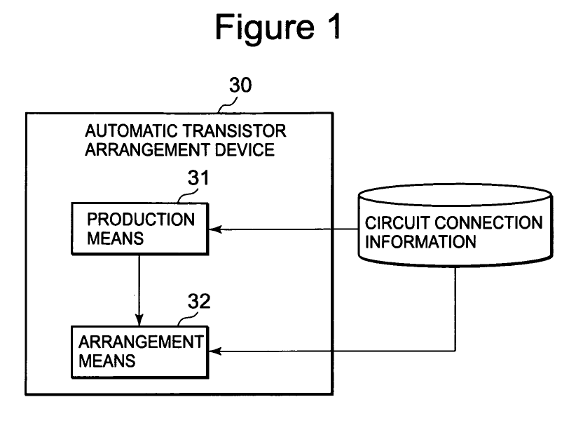

An automatic transistor arrangement device according to an exemplary embodiment of the present invention will be described with reference to the drawings. FIG. 1 is a block diagram illustrating a configuration of an automatic transistor arrangement device according to an exemplary embodiment of the present invention. Referring to FIG. 1, the automatic transistor arrangement device 30 includes production means 31 and arrangement means 32.

When first and second hard macro transistors arranged based on circuit connection information to adjoin each other are equal in the potential of diffusion region, the production means 31 produces a first programmable transistor obtained by removing unwanted diffusion region and/or unwanted contact in the first hard macro transistor and also produces a second programmable transistor obtained by removing unwanted diffusion region and/or unwanted contact in the second hard macro transistor. The arrangement means 32 arranges the first and second programmable transistors based on the circuit connection information.

### Exemplary Embodiment 1

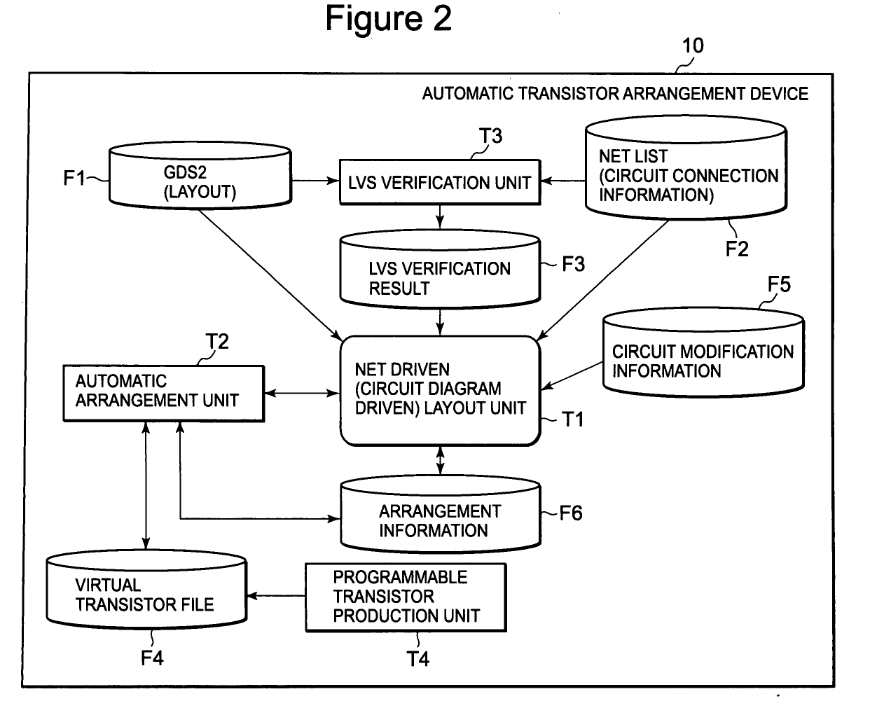

The automatic arrangement device according to exemplary embodiments of the present invention will be described with reference to the drawings. FIG. 2 is a block diagram illustrating a configuration of an automatic transistor arrangement device according to a first exemplary embodiment of the present invention. Referring to FIG. 2, the automatic transistor arrangement device 10 includes a net driven (circuit diagram driven) layout unit (“layout unit” for short) T1, automatic arrangement unit T2, LVS verification unit T3, programmable transistor production unit T4, GDS2 (layout) F1, net list (circuit connection information) F2, LVS verification result F3, virtual transistor file F4 and path modification information F5.

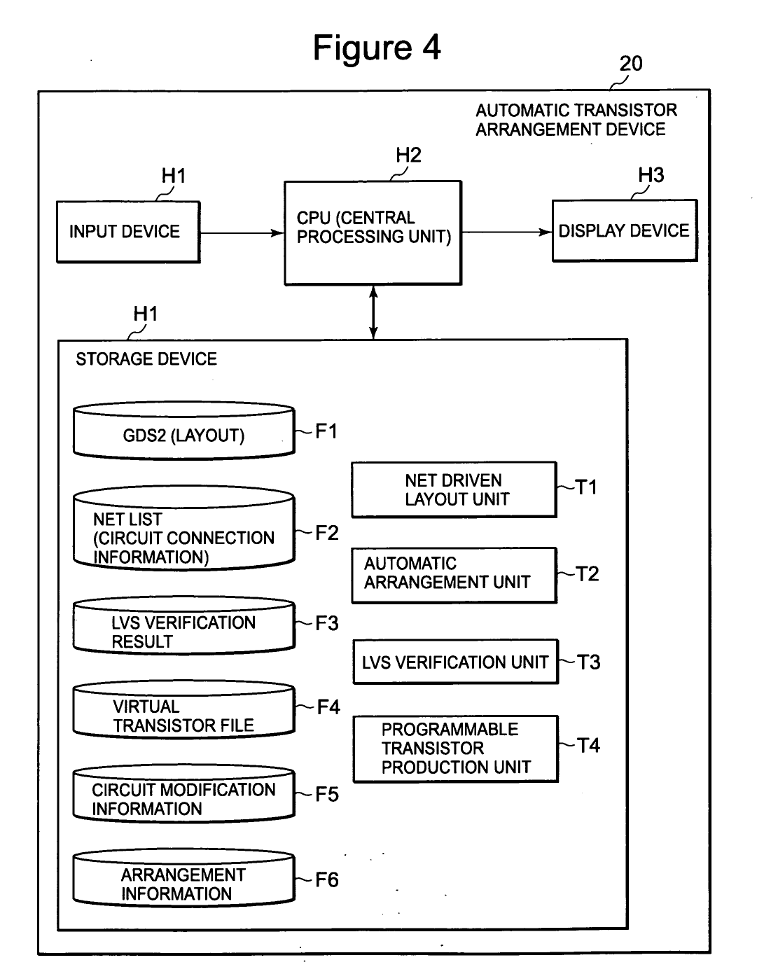

The automatic arrangement device may be implemented by a combination of software running on a computer and hardware as illustrated in FIG. 4. An automatic transistor arrangement device 20 includes an input device H1, CPU (Central Processing Unit) H2, display device H3 and storage device H4. The input device H1 includes a keyboard, mouse and the like, and is manipulated by an operator. The display device H3 is a liquid crystal display, CRT or the like and viewed by the operator. The storage device H4 is constituted of memory or hard disk; recorded on the storage device H4 are various types of files (F1 to F6) according to the exemplary embodiment, programs for implementing the above described units, and OS (not illustrated). The CPUH2 executes the programs stored in the storage device H4 according to commands received via the input device H1 and causes the display device H3 to display the execution result and also stores the execution result in the storage device H4.

The GDS2 (layout) F1 is a typical binary format file handled as layout data.

The LVS (Layout Versus Schematic) verification unit T3 receives GDS2F1 being layout information including hard macro transistors, and net list F2, and verifies whether or not the connection of a circuit element and the connection between circuit elements produced in the circuit design stage have been properly implemented in layout design, and outputs the verification result to the LVS verification result F3. The expression “hard macro transistor” as used herein means a transistor which has a fixed shape; for the circuit element, the size, the horizontal to vertical ratio and the like cannot be modified. The expression “programmable transistor” as used herein means a transistor for which the width of diffusion region of the transistor and the presence/absence of contact arrangement can be modified using parameters supplied from the outside.

The layout unit T1 receives the verification result F3, GDS2F1 and net list F2. The layout unit T1 associates, on a one-to-one basis, circuit elements stored in the net list F2 with hard macro transistors stored in the GDS2F1, and outputs circuit modification information modified based on the circuit modification information F5 to the arrangement information F6. The expression “circuit modification information” as used herein means details of circuit modification, i.e., modification information on the width or length of diffusion region of the circuit transistor and modification information on circuit connection.

The layout unit T1 shares rearrangement information with the automatic arrangement unit T2 and the arrangement information F6. The automatic arrangement unit T2 receives or outputs virtual transistor file F4. The programmable transistor production unit T4 outputs the virtual transistor file F4. The layout unit Ti records on the arrangement information F6, information in the circuit modification information F5, which is used to associate, on a one-to-one basis, circuit elements with hard macro transistors in the layout modification.

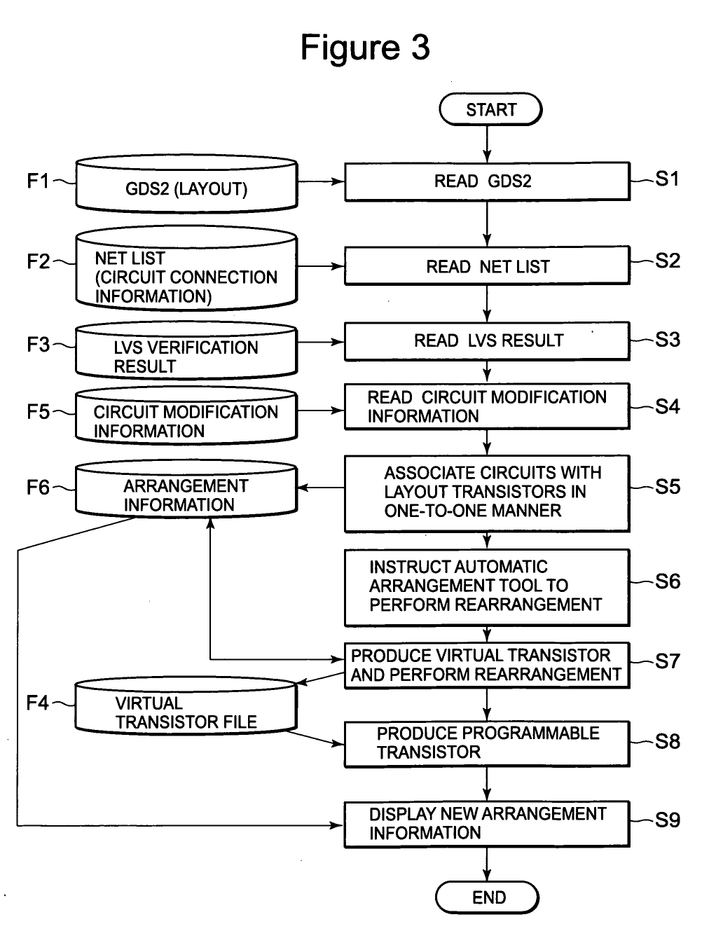

FIG. 3 is a flowchart illustrating the operation of the automatic transistor arrangement device 10 according to the exemplary embodiment.

The layout unit Ti reads GDS2F1, net list F2, LVS verification result F3 and circuit modification information F5 (steps S1 to S4). The layout unit T1 holds the information read in steps S1 to S4 (when the automatic transistor arrangement device is configured as illustrated in FIG. 4, the information is recorded on the storage device H4). Using data of LVS verification result F3 and GDS2F1 and data of net list F2, the layout unit T1 associates, on a one-to-one basis, circuits with layout transistors and stores the result in the arrangement information F6 (step S5). The layout unit T1 instructs the automatic arrangement unit T2 to execute processings of steps S7 and S8.

The automatic arrangement unit T2 executes the processings of steps S7 and S8 as rearrangement processings. The automatic arrangement unit T2 searches for hard macro transistors for which diffusion regions D have been coupled with each other. When the area of diffusion region D of the searched hard macro transistor can be reduced, the automatic arrangement unit T2 produces virtual transistors and performs rearrangement (step S7). Also, the automatic arrangement unit T2 stores the produced virtual transistors in the virtual transistor file F4. The automatic arrangement unit T2 performs automatic arrangement and stores the produced rearrangement information in the arrangement information F6.

The automatic arrangement unit T2 produces based on the virtual transistor file F4 produced in step S7, a programmable transistor having the same shape as the hard macro transistor for which it is determined in step S7 that area reduction is possible (step S8).

The layout unit T1 displays the arrangement information, produced by the processings of steps S7 and S8, and held in the arrangement information F6 (step S9).

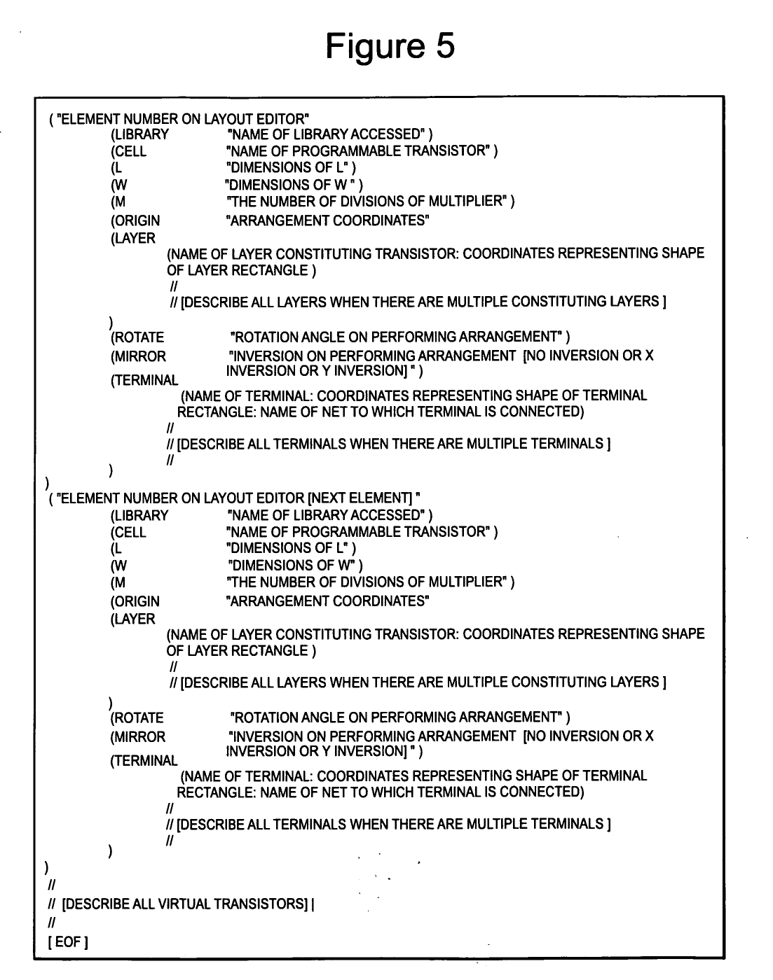

FIG. 5 illustrates an exemplary configuration of virtual transistor file F4. The virtual transistor file F4 contains element information on individual transistors obtained by detecting hard macro transistors contained in layout data before rearrangement and associating, on a one-to-one basis, the hard macro transistors with circuits. The element information includes the dimensions, arrangement coordinates, rotation, inversion and the like of the transistor. The virtual transistor file F4 is used to automatically produce a programmable transistor corresponding to a hard macro transistor.

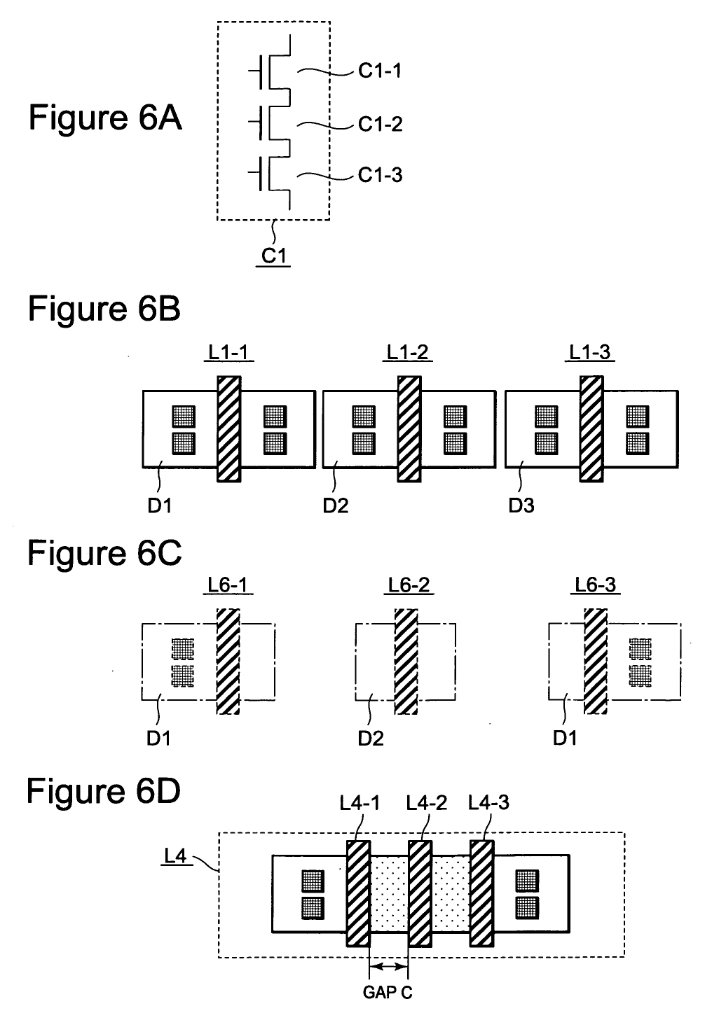

FIG. 6 is a view for describing a method of making diffusion regions of multiple hard macro transistors overlap and performing automatic arrangement by using the automatic transistor arrangement device according to the first exemplary embodiment of the present invention.

FIG. 6A illustrates circuit information stored in the net list F2. FIG. 6B illustrates layout information stored in the GDS2F1. FIG. 6C illustrates virtual transistors stored in the virtual transistor file F4. FIG. 6D illustrates layout information in which diffusion regions overlap.

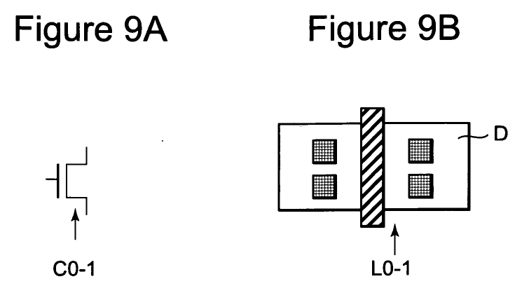

Firstly the layout unit T1 executes the processings of steps S1 to S4 and thereby acquires from the net list F2, information on a circuit element C1 constituted of three transistors C1-1 to C1-3 connected in series each having the same configuration as a hard macro transistor C0-1 illustrated in FIG. 9A. Further, the layout unit T1 acquires from the GDS2F1, layout information L0-1 corresponding to the hard macro transistor C0-1.

In step S5, the layout unit T1 acquires information for associating, in an one-to-one manner, the hard macro transistors C1-1 to C1-3 contained in the net list F2 with layouts L1-1 to L1-3 contained in the GDS2F1 and thereby performing layout, and stores the information in the arrangement information F6.

Subsequently, in step S6, the layout unit T1 instructs the automatic arrangement unit T2 to perform rearrangement using the arrangement information F6. The automatic arrangement unit T2 produces virtual transistor layouts L6-1 to L6-3 of including element information such as element dimensions required for overlapping of diffusion regions D1 to D3 of the layouts L1-1 to L1-3 (step S7).

The automatic arrangement unit T2 determines based on the information stored in the arrangement information F6 that the drain potential of the diffusion region D1 of the layout L1-1 is equal to the source potential of the diffusion region D2 of the layout L1-2 and also there is no other connection line. In this case, the automatic arrangement unit T2 removes a contact in the drain side of the layout L1-1 and leaves unchanged only that part of the diffusion region D1 in the drain side which corresponds to a gate-gate distance set based on the design criterion, and thereby produces the virtual transistor layout L6-1. Also, the automatic arrangement unit T2 removes a contact of the diffusion region D2 in the source side of the layout L1-2 and leaves unchanged only that part of the diffusion region D2 in the drain side which corresponds to a gate-gate distance set based on the design criterion, and thereby produces the virtual transistor layout L6-2.

Further, the automatic arrangement unit T2 determines that the drain potential of the diffusion region D2 of the layout L1-2 is equal to the source potential of the diffusion region D3 of the layout L1-3 and also there is no other connection line. In this case, the automatic arrangement unit T2 removes a contact in the drain side of the layout L1-2 and leaves unchanged only that part of the diffusion region D2 which corresponds to a gate-gate distance set based on the design criterion, and thereby produces the virtual transistor layout L6-2. Further, the automatic arrangement unit T2 removes a contact in the source side of the layout L1-3 and leaves unchanged only that part of the diffusion region D3 which corresponds to a gate-gate distance set based on the design criterion, and thereby produces the virtual transistor layout L6-3. Also, the automatic arrangement unit T2 stores the produced virtual transistor layouts L6-1 to L6-3 in the virtual transistor file F4 (step S7).

In the exemplary embodiment, there has been described the case in which diffusion regions of transistors are made to overlap. However, virtual transistors may be produced by appropriately using the dimensions defined by the design criterion, such as the distance between diffusion regions, gate gap and gate-contact gap.

The automatic arrangement unit T2 produces based on the virtual transistor file F4 information produced in step 7, layout L4 in which diffusion regions of programmable transistors L4-1 to L4-3 overlap (step S8). Here, as the programmable transistors L4-1 to L4-3, ones produced by the programmable transistor production unit T4 may be used.

The gap C between the gate of the programmable transistor L4-1 and the gate of the layout L4-2 in the layout L4 is expressed as the following formula (1).

gap C=(gate-gate distance) formula (I)

Here, the gate-gate distance parameter is set based on the design criterion determined according to the process. In this case,

(gate-gate distance)<(gate-contact distance)*2+(contact width)

The gap between the layout L4-2 and layout L4-3 is also equal to the gap C.

In the automatic transistor arrangement device 10 according to the exemplary embodiment, hard macro transistors contained in layout data before rearrangement are not used as they are, but the following processing is performed using the automatic arrangement unit T2 and virtual transistor file F4. That is, the automatic arrangement unit T2 produces virtual transistor file F4, and programmable transistors are automatically produced based on element information on individual transistors each associated, in an one-to-one manner, with circuit connection information on the dimensions, arrangement coordinates, rotation, inversion and the like of the transistor in the virtual transistor file F4. As a result, the layout unit T1 acquires a layout obtained by replacing hard macro transistors contained in the layout data before rearrangement with the produced programmable transistors.

In the gap between the programmable transistors after the replacement, there is no contact between the transistors, and the gate-gate distance can be set as the process minimum rule, so the effect of reducing the layout area is achieved.

Also, according to the automatic transistor arrangement device of the exemplary embodiment, the manual operation of replacing hard macro transistors with programmable transistors on a per transistor basis can be omitted. Further, according to the automatic transistor arrangement device of the exemplary embodiment, programmable transistor files are automatically produced based on information on virtual transistor stored in the virtual transistor file, so the design period can be shortened. Further, according to the automatic transistor arrangement device of the exemplary embodiment, the hard macro transistors are automatically replaced with automatically produced the programmable transistors, so the manual replacement operation can be prevented from being not fully performed.

### Exemplary Embodiment 2

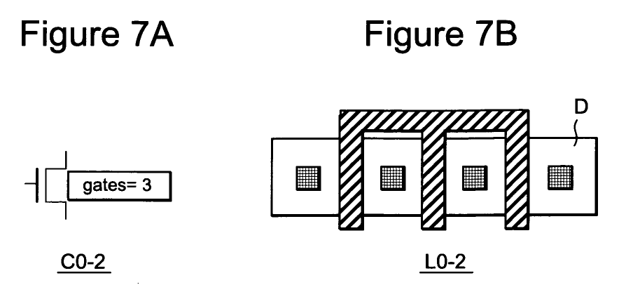

An automatic transistor arrangement device according to a second exemplary embodiment of the present invention will be described with reference to the drawings. FIG. 7A illustrates a circuit element for which the number of gate divisions is three. FIG. 7B illustrates a programmable transistor with three gate divisions corresponding to FIG. 7A.

Differently from exemplary embodiment 1, the programmable transistors produced by the programmable transistor production unit T4 are automatically arranged.

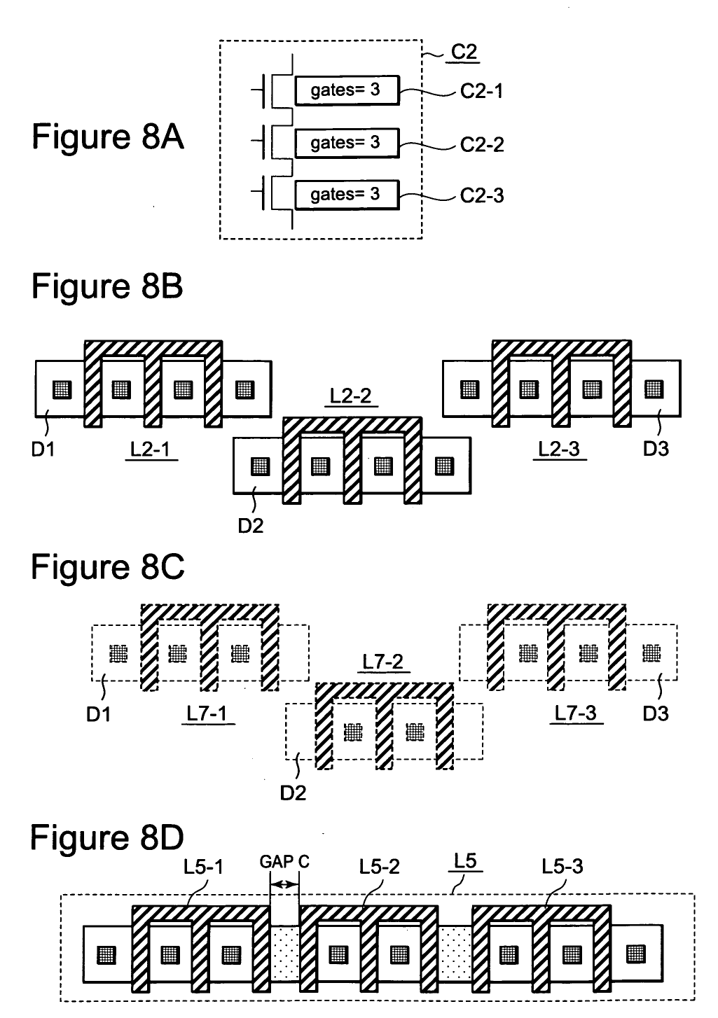

FIG. 8 is a view for describing a method of making diffusion regions of multiple programmable transistors overlap each other and automatically arranging the transistors by using the automatic transistor arrangement device according to the second exemplary embodiment of the present invention. Here, a programmable transistor, illustrated in FIG. 7A, for which the number of gate divisions is three is taken as an example.

The layout unit T1 acquires information on a circuit element C2 (transistors C2-1 to C2-3 of FIG. 8A) constituted of three transistors C0-2 connected in series, and reads three programmable transistors L0-2 (layouts L2-1 to L2-3 of FIG. 8B) contained in the GDS2F1, whereby circuit connection information on the programmable transistors C2-1 to C2-3 is associated, in an one-to-one manner, with the programmable transistors of layouts L2-1 to L2-3, so that layout information is provided.

The automatic arrangement tool T2 produces virtual transistor layouts L7-1 to L7-3 including element information such as element dimensions required for overlapping of diffusion regions D1 to D3 of the layouts L2-1 to L2-3 (step S7).

When the automatic arrangement tool T2 determines based on the information stored in the arrangement information F6 that the drain potential of the diffusion region D1 of the layout L2-1 is equal to the source potential of the diffusion region D2 of the layout L2-2 and also there is no other connection line, the automatic arrangement tool T2 removes a contact in the drain side of the layout L2-1 and leaves unchanged only that part of the diffusion region D1 in the drain side which corresponds to a gate-gate distance set based on the design criterion, and thereby produces the virtual transistor layout L7-1. Similarly, the automatic arrangement tool T2 removes a contact in the source side of the layout L2-2 and leaves unchanged only that part of the diffusion region D2 in the source side which corresponds to a gate-gate distance set based on the design criterion, and thereby produces the virtual transistor layout L7-2.

Further, when the automatic arrangement tool T2 determines that the drain potential of the diffusion region D2 of the layout L2-2 is equal to the source potential of the diffusion region D3 of the layout L2-3 and also there is no other connection line, the automatic arrangement tool T2 removes a contact in the drain side of the layout L2-2 and leaves unchanged only that part of the diffusion region D2 in the drain side which corresponds to a gate-gate distance set based on the design criterion, and thereby produces the virtual transistor layout L7-2. Similarly, the automatic arrangement tool T2 removes a contact in the source side of the layout L5-3 and leaves unchanged only that part of the diffusion region D3 in the source side which corresponds to a gate-gate distance set based on the design criterion, and thereby produces the virtual transistor layout L7-3. The automatic arrangement unit T2 stores the produced virtual transistor layouts L7-1 to L7-3 in the virtual transistor file F4.

In the exemplary embodiment, there has been described the case in which diffusion regions of transistors are made to overlap. However, virtual transistors may be produced by appropriately using the dimensions defined by the design criterion, such as the distance between diffusion regions, gate gap and gate-contact gap.

The automatic arrangement unit T2 reproduces based on the information of the virtual transistor file F4 produced in step S7, the programmable transistors L5-1 to L5-3 and thereby produces layout L5 in which the diffusion regions of the produced programmable transistors overlap (step S8).

In this case, the gap C between the gate of the layout L5-1 and the gate of the layout L5-2 is equal to the gap C of FIG. 6, and expressed as the above formula (1). The gap C between the gate of the layout L5-2 and the gate of the layout L5-3 is also equal to the gap C of FIG. 6.

In the automatic transistor arrangement device according to the exemplary embodiment, when virtual transistor file F4 is produced, information associated, in a one-to-one manner, based on the number of transistor gate divisions, with hard macro transistors such as layouts L2-1 to L2-3 are added to the virtual transistor file F4. Accordingly, it is possible to handle various hard macro transistor configurations. The above descriptions have been given based on the exemplary embodiments. However, the present invention is not limited to the above described exemplary embodiments.

Further, it is noted that Applicant's intent is to encompass equivalents of all claim elements, even if amended later during prosecution.

What is claimed is:

1. An automatic transistor arrangement method, comprising:
when first and second hard macro transistors are arranged adjacently to each other, based on a circuit connection information and potentials of diffusion regions of the first and second hard macro transistors are equal, producing a first programmable transistor obtained by removing an unwanted diffusion region or an unwanted contact in the first hard macro transistor, and producing a second programmable transistor obtained by removing an unwanted diffusion region or an unwanted contact in the second hard macro transistor; and
arranging the first and second programmable transistors based on the circuit connection information.

2. An automatic transistor arrangement device, comprising:
production means configured so that, when first and second hard macro transistors are arranged adjacently to each other, based on a circuit connection information and potentials of diffusion regions of the first and second hard macro transistors are equal, the production means produces a first programmable transistor obtained by removing an unwanted diffusion region or an unwanted contact in the first hard macro transistor, and produces a second programmable transistor obtained by removing an unwanted diffusion region or an unwanted contact in the second hard macro transistor; and
arrangement means configured to arrange the first and second programmable transistors based on the circuit connection information.

3. A method of arranging transistors, comprising:
obtaining an information of a circuit element where a first transistor and a second transistor are connected in series, from a netlist, each of the first and second transistors corresponding to a same hard macro transistor;
obtaining a layout corresponding to the hard macro transistor;
associating the layout with the first transistor and the layout with the second transistor;
determining whether a diffusion region of the first transistor is connected to a diffusion region of the second transistor, and whether the diffusion regions of the first and second transistors are supplied with a same voltage potential;
producing a first virtual transistor by removing a contact formed in the diffusion region of the first transistor and a second virtual transistor by removing a contact formed in the diffusion region of the second transistor, when the diffusion region of the first transistor is connected to the diffusion region of the second transistor and the diffusion regions of the first and second transistors are supplied with the same voltage potential; and
based on an information of the first and second virtual transistors, producing a layout by overlapping a diffusion region of a first programmable transistor corresponding to the first virtual transistor with a diffusion region of a second programmable transistor corresponding to the second virtual transistor.

4. The method as claimed in claim 3, further comprising:
reducing an area of the diffusion region of the first virtual transistor from an area of the diffusion region of the first transistor; and
reducing an area of the diffusion region of the second virtual transistor from an area of the diffusion region of the second transistor.
